(19) United States
(12) Patent Application Publication
(10) Pub. No.: US 2009/0182532 A1
(43) Pub. Date: Jul. 16, 2009

(54) MONITORING UNIT FOR PHOTOVOLTAIC MODULES

(76) Inventors: Joachim STOEBER, Kelkheim (DE); Tino STEICKERT, Woelfersheim (DE); Hans-Hermann HUNFELD, Westerkapplen (DE); Christian ROEHL, Kelkheim (DE)

Correspondence Address: BROWDY AND NEIMARK, P.L.L.C.;624 NINTH STREET, NW, SUITE 300, WASHINGTON, DC, 20001-5303, US

(21) Appl. No.: 12/348,872

(22) Filed: Jan. 5, 2009

(30) Foreign Application Priority Data
Jan. 5, 2008 (DE) 102008003272.7

(51) Int. Cl. G21C 17/00; H02H 3/00; G08B 21/00

(52) U.S. Cl. 702/183; 361/88; 340/661

(57) ABSTRACT

The invention relates to a monitoring unit for photovoltaic modules, wherein the modules are designed for a direct conversion of radiation energy, such as e.g. solar energy, into electric energy, and the system is designed function monitored, wherein each photovoltaic module (1-3) has assigned to it its own monitoring unit (4-6; 15, 16; 28) and all monitoring units are centrally monitored and documented by a control computer.

The invention relates to a monitoring unit for photovoltaic modules or other modules from the field of regenerative energies according to the preamble of claim 1.

A monitoring unit of this type has become known, for example, with the subject matter of Patent Disclosure DE 20 2006 00 073 U1. The subject matter there is a theft protection device that is implemented in the form of a mechanical protection arrangement, so that a removal of individual photovoltaic modules from a supporting structure results in a theft alarm.

With the subject matter of Patent Disclosure DE 20 2005 020 161 U1 another module monitoring of photovoltaic modules has become known, in which the photovoltaic panels are secured for the case of theft in such a way that a determination is made by means of a window comparator and a reference voltage that is programmed there, whether one or multiple photovoltaic panels were removed. Such a monitoring of a reference voltage on photovoltaic panels has the shortcoming, however, that no allowance can be made for the fact that the voltage that is put out by the photovoltaic panels decreases over their operable life, and a false theft alarm could therefore occur.

With the subject matter of Patent Disclosure DE 20 2006 007 613 U1, it has become known also to equip a photovoltaic system with a fire protection system; or with the subject matter of Patent Disclosure DE 10 2005 018 173 A1, to equip photovoltaics with a shut-down system that is triggered when a smoke sensor, water sensor or gas sensor issues an alarm, in order to thus cut off the entire photovoltaic system from the network being supplied.

It is a shortcoming of the above-mentioned printed publication, however, that only the entire photovoltaic system as a whole can be monitored and that it is not possible to individually monitor individual photovoltaic modules.

Such an individual monitoring of photovoltaic modules is important, however, in order to be able to determine whether an individual module has ceased to function or is impaired in its function because one or multiple strings on a panel have ceased to function or the module as a whole has ceased to function.

It is an additional shortcoming that, because of the non-existent individual monitoring of photovoltaic modules, it has not been known for documentation purposes up to now to prepare a documentation for each individual photovoltaic module in order to document precisely provable when the photovoltaic module has decreased in its performance or even ceased to function altogether. This is important, for example, in order to enforce warranty claims against the manufacturer or insurance company.

The invention is, therefore, based on the object of improving a monitoring unit for photovoltaic modules of the above type in such a way that it is now possible to centrally monitor each individual photovoltaic module individually for the presence or absence of a multitude of functions.

To meet this object, the invention is characterized by the technical teaching of claim 1.

A solar module, photovoltaic module, or solar generator, converts the light from the sun directly into electric energy. As its most important components it contains a plurality of solar cells.

Solar modules are used, individually or electrically interconnected into arrays, in photovoltaic systems, small-scale off-grid consumers, or for supplying power to spacecrafts.

A solar module is characterized by its electrical characteristics (e.g. open circuit voltage and short-circuit current.) These depend on the characteristics of the individual solar cells and on the electric interconnection of the solar cells within the module.

To meet the requirements for a system for solar generated power, solar cells are interconnected by means of a plurality of different materials into a solar module. This interconnection fulfills the following purposes:
1. Transparent, radiation resistant and weather resistant cover
2. Robust electrical connections
3. Protection of the brittle solar cell from mechanical influences
4. Protection of the solar cells and electrical connections from moisture
5. Adequate cooling of the solar cells
6. Accidental-contact protection of the electrically conducting components
7. Manipulation means and fastening means

It is a principal feature of the invention that there is now additionally provided directly in the junction box of each photovoltaic module, in which there is already provided in a manner known per se the connection printed circuit board, a printed circuit board (PCB) on which a multitude of function monitoring modules are provided.

In another embodiment, provision is made that the function module is disposed also in a box that is affixed separately on the panel and connected to the junction box.

With the technical teaching of the claimed subject matter, the essential advantage is now attained that a separate function module for monitoring and controlling the functions is now assigned individually to each photovoltaic module so that, also when a photovoltaic module is replaced, the function module that is provided in the junction box is replaced individually as well. In this manner each photovoltaic module is assigned its own monitoring unit, and all assigned monitoring units are centrally monitored and documented by a control computer. Of importance, therefore, is the individual management of each individual photovoltaic module, with the term photovoltaic module being understood to mean a panel on which one or a plurality of strings of photovoltaic cells are arranged that are combined and electrically interconnected in the junction box, which, as a rule, is disposed on the back of the panel.

In accordance with the invention, there is now additionally provided in this junction box or via a box that is to be installed separately, which is assigned to each panel, the inventive function module. This provides for an individual assignment to each individual panel. In this context it is particularly advantageous that this inventive function module will be installed in the junction box or also in a separate junction box, because this function module can thus be installed retroactively and it can also already be integrated into the junction box to begin with, or installed separately on the panel.

Since the ribbon contact points for the various strings already exist in the junction box, it is particularly easy to integrate precisely in the junction box the inventive function module, or to install via the also already existing connecting cables the inventive function module in a separate junction box.

The below-described function modules are integratable into the junction box of a photovoltaic module.

I. Radio Module:
Radio standard, according to known technologies, e.g. GSM or telemetry
Encoding
Configurable via WEB Tool
Settings must be stored, also in case of a voltage interruption

A radio module according to the invention refers to a ready-made transceiver assembly of any desired radio technology, such as Bluetooth, WLAN or ZigBee.

The modules are implemented primarily as extension cards that are then plugged into a mainboard. Via the contacts, the voltage supply and the data communication then takes place. During the communication via the radio module, the mainboard sends to the module only the data that is to be transmitted, and the module then transmits it in accordance with the respective radio standard. The radio module thus takes on the send and receive protocol, the encoding, and the administration of the data, as well as its analog preparation, such as modulation, mixing, filtering and amplification.

The use of radio modules can considerably reduce the production costs of a product that supports different radio technologies, because only the radio module that is necessary for the respective radio standard needs to be replaced or installed. The main assembly remains identical, which significantly reduces the development and manufacturing costs.

Some manufacturers only develop and produce radio modules, which are then purchased by other manufacturers and installed in their products. This is particularly widespread with GPS modules.

II. Motion Sensor:
2-3 D motion sensor (depending on the cost factor).
The sensor must register the movements in case of theft and issue an alarm via the radio module.
Since the installations are outdoors, the exterior environmental factors (wind, storm, temperatures, etc.) must be taken into account
During high winds and storms a number of modules report movement signals, which must be cross-verified by means of a software routine of the application server.
Via the movement sensor, a kind of position finding on the site that is being monitored

III. Temperature Sensor:
Monitoring of the ambient temperature in case of fire.
When a certain temperature value is exceeded, signal per radio to host.
Serves for fire monitoring and individual module cut-off from the total string.
PCB is installed in the so-called junction box, which is always installed on the back of the solar modules, i.e. in the shade, or implemented as a box that is to be installed separately.

IV. Voltage and Electrical Current Measurement:
Serves for monitoring the solar modules.
For transmitting the total voltage and current values of the individual modules.
Identification of drops in output, or failures.

V. Electrical Power Supply of the PCB:
Direct current voltage supply DC/DC.
Wide-range input from 2-100 Volt (voltage supply through solar module, voltage level dependent on position of the sun.)
The voltage input may decrease, since one could also tap off the individual module string (module is divided into individual strings.)
Input range then possibly from 2 to approximately 30 V.
At a voltage input of less than 2 V, battery operation.
Battery supply during the night (should guarantee a life of approximately 48 hours)
During the day, recharging of the battery (life of the solar modules is calculated at 25 years, the battery should also reach this operable life—desired)
Option of a permanent external voltage supply.

VI. Configuration Option:
Configuration options for the individual functions
Radio settings
Temperature sensor, etc.
Web Tool

It can be gathered from the above description that a wireless data transmission exists between a radio interface, which is provided on the function module, and a central server. Preferably, this wireless data transmission is carried out over a WLAN. However, other transmission protocols exist as well, such as e.g. Zegbe, or Nanonet, or also any desired type of bi-directional transmission as it is known in the prior art.

It is important that, with the wireless transmission to a local server a multitude of individual photovoltaic modules can now be monitored and managed, which has not been known up to now. The management function of each individual photovoltaic module is particularly important, in order to—as explained above—obtain a seamless documentation of the operational life of this photovoltaic module.

Furthermore, in addition to the wireless data transmission a wired data transmission can take place as well, in such a way, for instance, that a transmission takes place via a databus. In a particularly simple manner it is preferred in this case if the data transmission takes place via the current collecting line, onto which an appropriate bi-directional data transmission protocol is modulated.

Of course, a modulator must then be provided at the feed-in and a demodulator at the receiving end.

Provision is made for bi-directional data traffic over this line as well.

It is important, both with the radio-based transmission as well as with the wired transmission, that a bi-directional data transfer takes place, for the reason that programming of each individual function module can be carried out also from the local server. Such a programming must be provided, for example, if, in case of an alarm or a switching off, the photovoltaic module is being reset because it was cut off from the electric current collecting bus earlier.

In other respects, a number of additional functions will be assigned to the function module as well, which, by themselves and in combination with each other—in any desired combination thereof—are considered essential to the invention.

It is important that one can now, from the central server, isolate in a very simple manner each individual photovoltaic module from the supply string in such a way that a switch-off module exists that is activated by the microprocessor provided on the function module. In case of a fire it is accordingly necessary or feasible that the respective individual photovoltaic module is switched off by the local server by means of an appropriate switch-off signal, because the corresponding switch-off command was transmitted wired or by radio transmission to the respective individual photovoltaic module.

Of course, provision is made in this context that each photovoltaic module has an individual unique address and if the transmission takes place in WLAN operation this will be an IP address.

It is particularly advantageous in this context that the function module has provided on it also the switch-off module and that this switch-off module has one or a plurality of sensor inputs, so that a switch-off command can be issued not only by means of a radio or wire transmission, but the corresponding function is also integrated directly on the function module in the respective individual photovoltaic module. Accordingly, the switch-off command can be issued in the photovoltaic module itself, for instance if a temperature sensor registers an impermissibly high temperature and then activates the switch-off module.

It is understood that a number of additional functions are integrated on the function module PCB as well, all of which are considered essential to the invention, both in combination with one another and by themselves. A position sensor, for instance, that incorporates a particularly simple theft protection, must be considered such an additional important function. The reason being that if the photovoltaic module (i.e. the entire panel) is removed or otherwise altered in its position, the position sensor issues an alarm and activates the microprocessor provided on the function module PCB, which, in turn, transmits a corresponding alarm command to the local server.

It must be regarded as another essential advantage of the invention that the local server can manage a multitude, e.g. 100 or 1000 or more, of individual photovoltaic modules with a single software program, so that it is possible e.g. in a very simple manner to perform a presence check. A determination is made by means of a corresponding wireless or wired polling command that is transmitted to all photovoltaic modules, whether the respective photovoltaic module is still there, whether it delivers the required output.

Additionally, it is important that the respective photovoltaic module is completely autarkic, so that the corresponding functions act on the photovoltaic module even when there is no radio or wire transmission.

Additionally, it is important that the functionality is also maintained during the night, since, when the corresponding input voltage is not present, an electric power buffer exists on the function module PCB that supplies the proper input voltage for the microprocessor and for the function modules that are then turned on.

The inventive function module can be connected in the junction box and also frictionally or formfittingly affixed as an additional element on the module/assembly to be monitored or operated. The connection in this extension stage is made on the primary side by means of connecting cables to the junction box and on the secondary side to downstream modules or assemblies. A manipulation of the main module is not required in this extension stage. The inventive function module is suitable also for facilities and equipment monitoring.

The subject of the present invention is attained not only from the subject of the individual claims, but also from the combination of the individual claims with one another.

All of the specifications and characteristics disclosed herein, including in the abstract, and in particular the three-dimensional embodiment shown in the drawings, are claimed as essential to the invention, to the extent that they are novel over the prior art, either individually or in combination.

The invention is further described below in conjunction with drawings that show only one possible embodiment. Other characteristics and advantages of the invention that are essential to the invention will become apparent from the drawings and from their description.

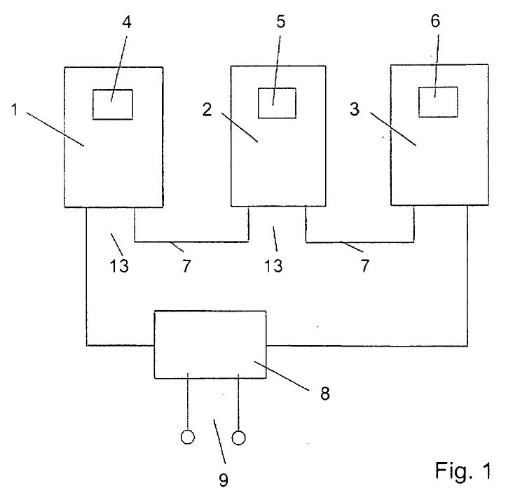

FIG. 1 [shows] schematically a series connection of 3 photovoltaic modules

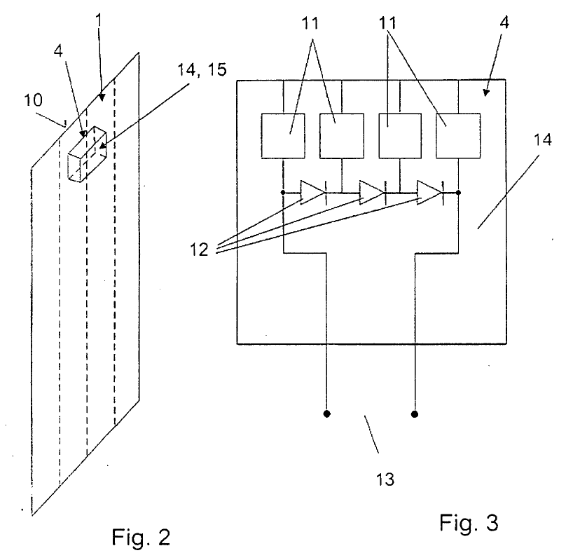

FIG. 2 [shows] the perspective rear view of a photovoltaic module with a junction box

FIG. 3 [shows] the top view of the junction box with the provided connection PCB

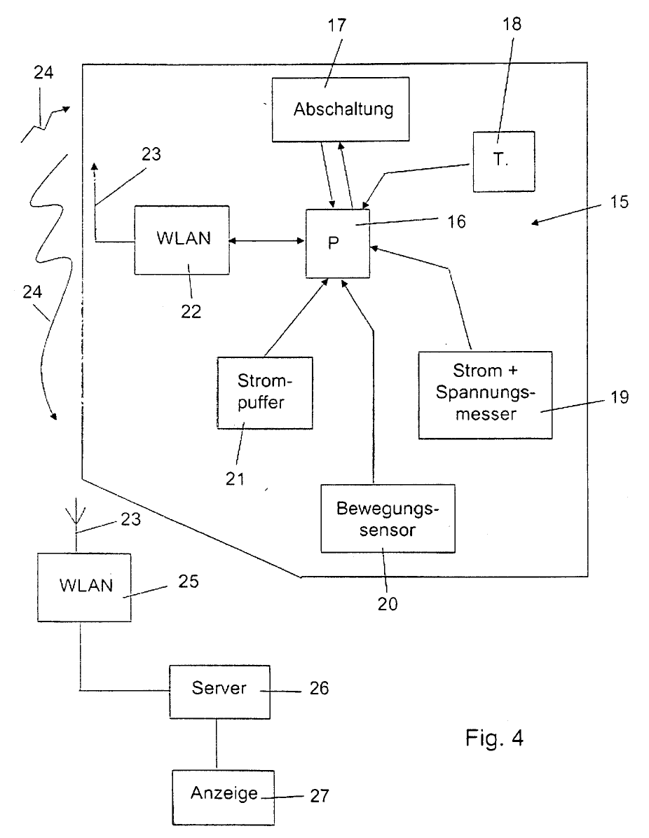

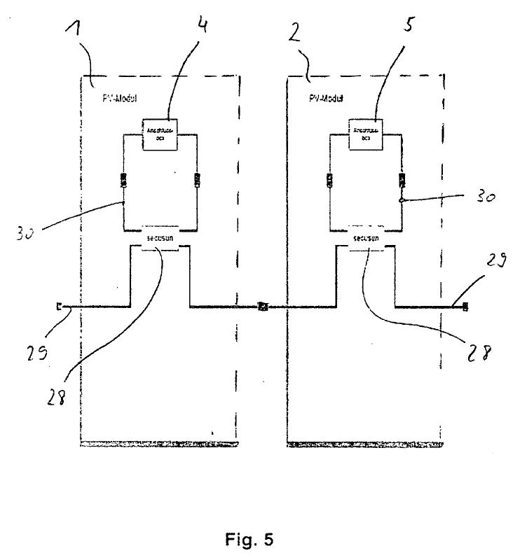

FIG. 4 [shows] a schematicized block diagram of a function module PCB with identification of the various function modules

FIG. 5 [shows a] connection as an external function module with a separate housing

FIG. 1 depicts a series connection of 3 photovoltaic modules 1-3 that are serially connected to one another via corresponding connecting lines. In a manner known per se the series connection is routed into an inverter 8, to which the connection 9 is made for the feed-in to a superordinate AC mains.

Each photovoltaic module is equipped on its back with a junction box 4-5-6, and according to FIGS. 2 and 3 it is apparent that it is a watertight box that is closeable with a cover, with a connection PCB 14 provided in the junction box 4-6. This connection PCB is shown in FIG. 3. It is apparent that the strings that are arranged in each photovoltaic module are connected together via ribbon contact points 11, in the depicted exemplary embodiment with three strings arranged on one panel and the depicted ribbon contact points isolated in each case by bypass diodes 12 in order to guarantee, in case of a failure of one string, that the electrical current continues to flow through the other strings and can be fed into the network.

Disposed on the front of each panel are a multitude of solar cells 10 that are connected together into the above-mentioned three strings, as can be seen in FIG. 3.

At the connector 13 of the junction box the junction is created to the line 7, and thereby to the series connection to the adjoining photovoltaic module.

According to the invention it is now provided that there is disposed in the junction box 4-6 in addition to the connecting PCB 14 also a function module PCB 15, which is shown in detail in FIG. 4.

Disposed in the center of the function module PCB is a microprocessor 16, whose power is supplied either by the photovoltaic module 1-3 itself, or which is supplied by a battery buffer 21 when there is no more incoming solar radiation, so as to provide the necessary supply voltage for the microprocessor 16 and for the function modules disposed on the function module PCB 15.

It is important that a switch-off module 17 is provided, which provides for a central switching off of each individual photovoltaic module 1-3. The switch-off module 17 is activated by the microprocessor 16 and, in case of a fire or temperature overload (see temperature module 18) switches off the entire photovoltaic module 1-3.

Also provided is an output module 19, with which the electric current and voltage of the respective individual photovoltaic module 1-3 is monitored. Accordingly, the generated voltage is monitored on one hand and the generated electricity on the other hand, in order to thus obtain a statement with respect to the function of the photovoltaic module. The output module 19 registers the sum of the strings that are arranged on the panel, with, for example, 3 strings arranged on one panel according to FIG. 2.

Of course the invention can also be implemented in such a way that that the voltage and current of each individual string on the photovoltaic module are monitored, which, however, leads to increased circuitry requirements.

Monitoring the output of each individual photovoltaic module is particularly important for documentation and facility design purposes, since it provides for a seamless monitoring of the efficiency of each individual photovoltaic module.

Provided on the function module PCB 15 as an additional function module is a position sensor 20, which is designed, for instance, as an acceleration sensor or position sensor. Any time the entire panel of a photovoltaic module is impermissibly altered in its position, e.g. in such a way that it is lifted off from its installation location, or that impermissible vibrations act on it, or that it is destroyed (vandalism), the position sensor 20 responds and thereby activates the microprocessor which, in turn, then transmits a corresponding radio command via the radio interface 22 to the control computer 26.

From the above disclosure it becomes clear that a multitude of function modules are combined on the function module PCB 15 and that all function modules are connected via the microprocessor and via a wireless or wired data transmission via the interface and via the depicted radio transmission path 24 to the radio interface 25 on the server 26.

On the control computer 26, a monitoring and documentation software is running that is capable of monitoring a multitude of individual photovoltaic modules, also individually. All monitoring times and the monitoring data are routed to a central analysis 27 where they are displayed and analyzed.

In this manner it is possible for the first time to individually monitor individual photovoltaic modules over a long period of time (e.g. over a life of 20 years or more) and to immediately receive, in the case of impaired functions, in the case of an alarm or theft, or in the case of other operational impairments, an individual message regarding this individual photovoltaic module.

In addition to the wireless radio transmission via the radio transmission path 24 and antennas 23 that are provided there, a wired transmission may, of course, take place as well, as described at the beginning.

It is important that one is able to determine via the unique address, which, of course, is individually assigned to each photovoltaic module, in a simple manner the location of the photovoltaic module, in order to be able to access precisely this photovoltaic module in case of a required service.

In this manner a simple replacement of defective photovoltaic modules is possible as well, with the replacement being registered via the microprocessor and also reported to the central control computer 26 in order for the running log that is being maintained to be updated accordingly.

The central monitoring of each individual photovoltaic module also provides the added advantage that, in case of an impaired output of one or multiple photovoltaic modules, this module 1-3 that is impaired in its output is switched off via the switch-off module 17 in order to thus maintain the net voltage as a whole and circumvent the undesired high resistance that was caused as a result.

With an output monitoring by means of the output module 19 it is also possible to determine whether there is snow on the system or whether other soiling adversely affects the performance of the system.

Since all data of the function modules on the function module PCB 15 are continually transmitted over the data transmission path to the control computer 26, such a decreased output can be identified at any point in time, and remedies can be initiated individually on the respective impaired module 1-3.

FIG. 5 shows a modified exemplary embodiment, in which the inventive function module is provided externally in a separate housing (junction box 28). This clarifies that the function module may be disposed either in the junction box 4-6 as per FIGS. 1 through 4, or also frictionally or formfittingly affixed as an additional element on the module 1, 2 to be monitored. The connection of the function module 14, 15 is made in a separate junction box 28 that is connected to the module 1-3 and connected on the primary side by means of a connecting cable 30 to the junction box 4 on the module side, and on the secondary side by means of a connecting cable 29 to the connector of the downstream module and junction box 28 located there. As a result, replacing the module 1, 2, therefore, no longer requires any manipulation of the main module. The arrangement of the function PCB 14,15, in a separate junction box 28 accordingly is suitable for facility monitoring and for equipment monitoring.

### DRAWING LEGEND

1 Photovoltaic module

2 Photovoltaic module

3 Photovoltaic module

4 Junction box

5 Junction box

6 Junction box

7 Interconnecting conductor

8 Inverter

9 Connector

10 Solar cell

11 Ribbon contact point

12 Bypass diode

13 Connector

14 Connecting PCB

15 Function module PCB

16 Microprocessor

17 Switch-off module

18 Temperature module

19 Output module

20 Position sensor

21 Battery buffer

22 Radio interface

23 Antenna

24 Radio transmission path

25 Radio interface (server)

26 Control computer

27 Analysis

28 Separate junction box

29 Connecting cable (secondary)

30 Connecting cable (primary)

1. A monitoring unit for photovoltaic modules, wherein the modules are designed for a direct conversion of radiation energy into electric energy, and the system is designed function monitored, wherein each photovoltaic module (1-3) has assigned to it its own monitoring unit (4-6; 15, 16; 28) and all monitoring units are centrally monitored and documented by a control computer.

2. A monitoring unit for photovoltaic modules, wherein the modules are designed for a direct conversion of radiation energy into electric energy and the system is designed function monitored, wherein the monitoring unit, which is designed as a function module (14, 15), is disposed in a separate junction box (28) that is affixed on the panel of the photovoltaic module (1-3) and, in turn, connected to the junction box (4-6) of the module.

3. A monitoring unit according to claim 1, wherein each photovoltaic module (1-3) has individually assigned to it its own function module (14, 15) for monitoring and control of the functions, so that when a photovoltaic module is replaced the function module (14, 15) that is provided in the junction box (4-6; 28) is replaced individually along with it.

4. A monitoring unit according to claim 1, wherein, disposed on the front of the photovoltaic module (1, 2, 3) are a multitude of solar cells (10) that are connected together via strings, wherein on a connector (13) provided in the junction box (4, 5, 6) a junction is created via a line (7) to the series connection of the adjoining photovoltaic module (1, 2, 3).

5. A monitoring unit according to claim 1, wherein the junction box (4, 5, 6) is disposed on the back of the photovoltaic module (1, 2, 3) and designed watertight and has a connection PCB (14) and a function module PCB (15), wherein strings that are arranged on the connection PCB (14) are connected together via ribbon contact points (11) that are isolated from each other by means of bypass diodes (12) and guarantee a continued flow of current if one string fails.

6. A monitoring unit according to claim 1, wherein the function monitoring module (17 to 20) is designed as a switch-off module (17), and/or as a temperature module (18), and/or as an output module (19), and/or as a position sensor (20), wherein a radio interface (22) creates a wireless data transmission to a central control computer (26).

7. A monitoring unit according to claim 1, characterized wherein the function module PCB (15) has a microprocessor (16) that is supplied with electric power by the photovoltaic module (1, 2, 3) itself, or in case of an absent supply voltage due to an absence of incoming solar radiation, by a provided battery buffer (21), wherein the microprocessor (16) activates a switch-off module (17) provided on the function module PCB (15) that switches off the photovoltaic module (1, 2, 3) in case of a fire or in case of a temperature overload while maintaining the series connection to adjoining photovoltaic modules.

8. A monitoring unit according to claim 1, wherein the function module PCB (15) has an output module (19) that monitors the current and voltage of the respective photovoltaic module (1, 2, 3) and in case of a reduced output switches it off via the switch-off module (17) so as to maintain the net voltage and the resistance, wherein the output module (19) registers the sum of the strings that are arranged on the module (1, 2, 3).

9. A monitoring unit according to claim 1, wherein the function module PCB (15) has a position sensor (20) that, in case of a change in position, and/or in case of vibrations, and/or in case of a destruction of the photovoltaic module (1, 2, 3), activates the microprocessor (16), which transmits a radio command over the provided radio interface (22) to the control computer (26).

10. A monitoring unit according to claim 1, wherein the control computer (26) has a monitoring and documentation software that individually monitors the photovoltaic modules (1, 2, 3), wherein the monitoring times and monitoring data are routed to a central analysis (27), analyzed and displayed, whereby any need to replace a photovoltaic module (1, 2, 3) is detected.

11. A monitoring unit according to claim 1, wherein a radio interface (22) creates, by means of antennas (23), a wireless transmission over a radio transmission path (24), wherein each photovoltaic module (1, 2, 3) has assigned to it a unique address whereby an identification of the location of the photovoltaic module (1, 2, 3) and access to the same is provided.

12. A monitoring unit according to claim 1, wherein the function monitoring modules (16 through 22) of the photovoltaic module (1, 2, 3) that are disposed in the junction box (4, 5, 6) are designed retrofittable and assigned to a monitoring unit that is centrally monitored, controlled and documented by a control computer (26).

13. A monitoring unit according to claim 1, wherein the connection of the function module (14, 15) is made in a separate junction box (28) that is connected to the module (1-3) and that is connected on the primary side by means of a connecting cable (30) to the junction box (4) on the module side, and on the secondary side by means of a connecting cable (29) to the connector of the downstream module and junction box (28) provided there.

14. A monitoring unit according to claim 3, wherein each photovoltaic module (1-3) has individually assigned to it its own function module (14, 15) for monitoring and control of the functions, so that when a photovoltaic module is replaced the function module (14, 15) that is provided in the junction box (4-6; 28) is replaced individually along with it.

15. A monitoring unit according to claim 2, wherein, disposed on the front of the photovoltaic module (1, 2, 3) are a multitude of solar cells (10) that are connected together via strings, wherein on a connector (13) provided in the junction box (4, 5, 6) a junction is created via a line (7) to the series connection of the adjoining photovoltaic module (1, 2, 3).

16. A monitoring unit according to claim 2, wherein the junction box (4, 5, 6) is disposed on the back of the photovoltaic module (1, 2, 3) and designed watertight and has a connection PCB (14) and a function module PCB (15), wherein strings that are arranged on the connection PCB (14) are connected together via ribbon contact points (11) that are isolated from each other by means of bypass diodes (12) and guarantee a continued flow of current if one string fails.

17. A monitoring unit according to claim 2, wherein the function monitoring module (17 to 20) is designed as a switch-off module (17), and/or as a temperature module (18), and/or as an output module (19), and/or as a position sensor (20), wherein a radio interface (22) creates a wireless data transmission to a central control computer (26).

18. A monitoring unit according to claim 2, wherein the function module PCB (15) has a microprocessor (16) that is supplied with electric power by the photovoltaic module (1, 2, 3) itself, or in case of an absent supply voltage due to an absence of incoming solar radiation, by a provided battery buffer (21), wherein the microprocessor (16) activates a switch-off module (17) provided on the function module PCB (15) that switches off the photovoltaic module (1, 2, 3) in case of a fire or in case of a temperature overload while maintaining the series connection to adjoining photovoltaic modules.

19. A monitoring unit according to claim 2, wherein the function module PCB (15) has an output module (19) that monitors the current and voltage of the respective photovoltaic module (1, 2, 3) and in case of a reduced output switches it off via the switch-off module (17) so as to maintain the net voltage and the resistance, wherein the output module (19) registers the sum of the strings that are arranged on the module (1, 2, 3).

20. A monitoring unit according to claim 2, wherein the function module PCB (15) has a position sensor (20) that, in case of a change in position, and/or in case of vibrations, and/or in case of a destruction of the photovoltaic module (1, 2, 3), activates the microprocessor (16), which transmits a radio command over the provided radio interface (22) to the control computer (26).

21. A monitoring unit according to claim 2, wherein the control computer (26) has a monitoring and documentation software that individually monitors the photovoltaic modules (1, 2, 3), wherein the monitoring times and monitoring data are routed to a central analysis (27), analyzed and displayed, whereby any need to replace a photovoltaic module (1, 2, 3) is detected.

22. A monitoring unit according to claim 2, wherein a radio interface (22) creates, by means of antennas (23), a wireless transmission over a radio transmission path (24), wherein each photovoltaic module (1, 2, 3) has assigned to it a unique address whereby an identification of the location of the photovoltaic module (1, 2, 3) and access to the same is provided.

23. A monitoring unit according to claim 2, wherein the function monitoring modules (16 through 22) of the photovoltaic module (1, 2, 3) that are disposed in the junction box (4, 5, 6) are designed retrofittable and assigned to a monitoring unit that is centrally monitored, controlled and documented by a control computer (26).

24. A monitoring unit according to claim 2, wherein the connection of the function module (14, 15) is made in a separate junction box (28) that is connected to the module (1-3) and that is connected on the primary side by means of a connecting cable (30) to the junction box (4) on the module side, and on the secondary side by means of a connecting cable (29) to the connector of the downstream module and junction box (28) provided there.
